(19) United States
(12) Patent Application Publication
(10) Pub. No.: US 2007/0259308 A1
(43) Pub. Date: Nov. 8, 2007

(54) Stomatological Tip

(76) Inventor: Yury Mikhailovich Rogovsky, Moscow (RU)

Correspondence Address: SYNNESTVEDT & LECHNER, LLP, 1101 MARKET STREET, 26TH FLOOR, PHILADELPHIA, PA, 19107-2950, US

(21) Appl. No.: 10/583,855

(22) PCT Filed: Dec. 17, 2003
(86) PCT No.: PCT/RU03/00563

§ 371 Date: Oct. 6, 2006

(30) Foreign Application Priority Data
Dec. 17, 2003 (RU) 2003135402

(51) Int. Cl. A61C 3/00

(52) U.S. Cl. 433/29

(57) ABSTRACT

The stomatological tip comprises a head accommodating a means for holding a stomatological instrument, a tip body having a socket to receive the head. The socket to receive the head is capable of providing a complete revolution of the head. The head is provided with a source of optic radiation. The guard is made fast on a part of the head outer surface. The electric power source having a positive and a negative lead appears as a twin power cord. The source of optic radiation appears as at least one light guide electrically connected to the power supply source via electrical connectors accommodated in the body and head, and the electric conductor enclosed in the conduit provided in the body and in the cylinder-shaped groove and circular groove. The electrical connector accommodated in the head appears as a plug-and-receptacle assembly.

### TECHNICAL FIELD

The present invention relates to medical engineering, more specifically, to a stomatological tip.

### BACKGROUND ART

Known from application Ser. No. 96/101,748 seeking for issue of a patent of the Russian Federation and published on May 10, 1998 is a stomatological instrument comprising a head with a retainer chuck for stomatological instruments, a neck, a body, and a system of mechanical actuation for the retainer chuck, the axis of which while making an angle with the head pivot axis is adapted to form, in combination therewith and depending on the modification, the working surface from a full circle to a complete cone, said working surface having working points, when the head performs a full revolution about its own axis.

A disadvantage inherent in said known device resides in that the head body protruding transversely to a grip-body, thereby complicating manipulation with the instrument in the patient's oral cavity. Another disadvantage inherent in the known devise consists in the lack of a source of optical radiation on the head of the stomatological instrument which further complicates functioning of the instrument.

A stomatological tip is known from RF U.S. Pat. No. 2,030,904 published on Mar. 20, 1995, comprising a grip-body provided with air inlet and outlet ducts, a head having a body protruding sideways.

In the known tip stomatological instrument is mounted in a collet holder connected to the turbine and has a common pivot axis therewith. Said device comprises a source of optical radiation accommodated inside the grip-body and the head.

Said device suffers from a low performance reliability due to a possible disruption of the light guide disposed inside the grip-body and the head, a complicated arranging the light guide, as well as loss of light radiation during its passing along the light guide. Furthermore, the known stomatological tip lacks protection of the light radiation against mechanical damages.

### BRIEF DESCRIPTION OF THE DRAWINGS

The construction arrangement of the proposed stomatological tip is illustrated with reference to the accompanying drawings, wherein:

FIG. 1 is a general view of the stomatological tip, according to the invention; and

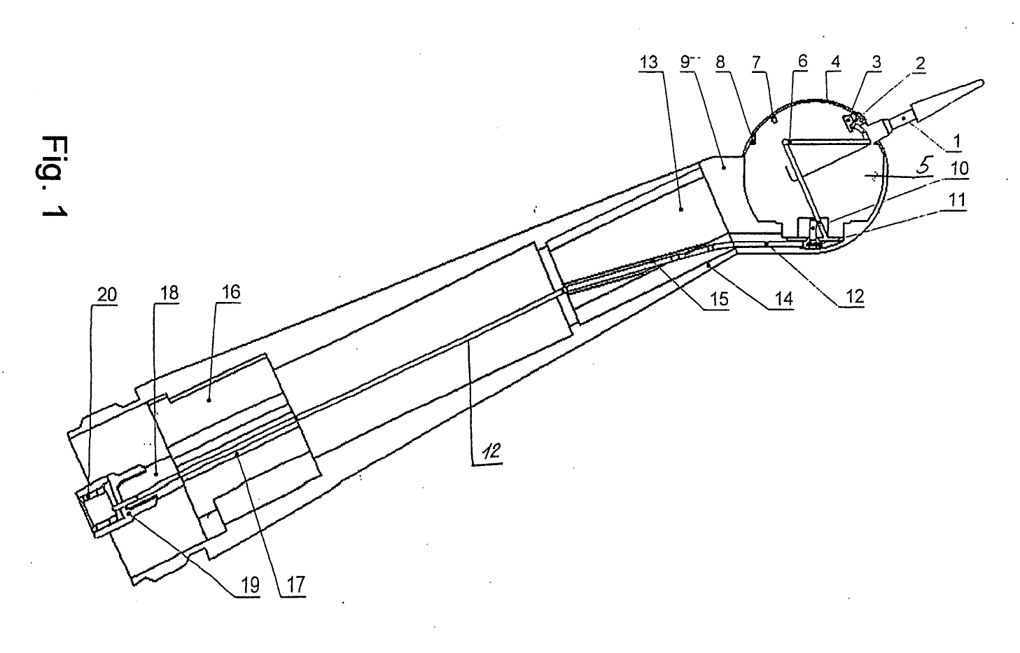

FIG. 2 a sectional view of the stomatological tip, according to the invention.

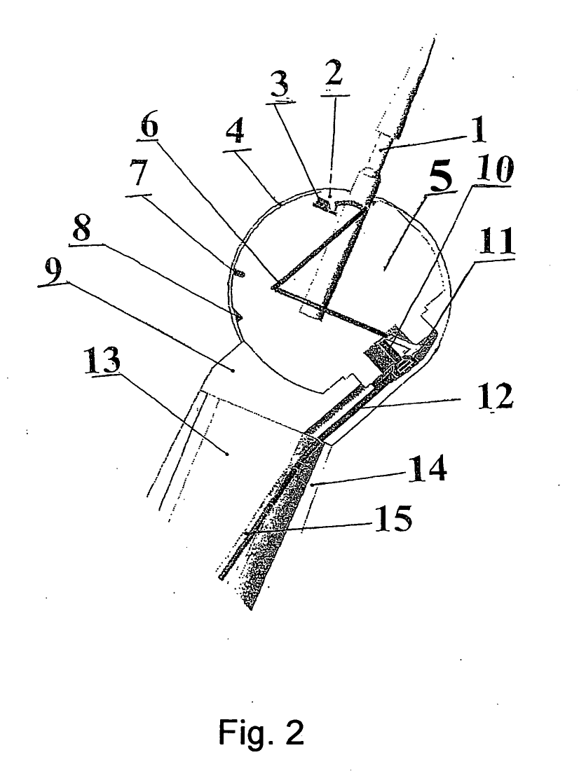

### SUMMARY OF THE INVENTION

An object of the present invention is to provide a simple and reliable stomatological tip having a swivel head and a light-emitting diode (LED), making it possible to substantially extend applicability of stomatological instruments and to considerably facilitate manipulating therewith in patient's oral cavity.

The object stated before is accomplished due to the fact that the stomatological tip comprising a head accomodating a means for holding a stomatological instruments, a tip body having a socket to receive the head, said socket being capable of providing a complete revolution of said head which is provided with a source of optic radiation, and stomatological tip being further provided with an electric power source having a positive and a negative lead appearing as a twin power cord, and the source of optic radiation appears as at least one light guide electrically connected to the power supply source via electrical connectors enclosed in the body and head, an electric conductor enclosed in a conduit provided in the body, and in a cylinder-shaped groove and a circular groove, while the electrical connector accomodated in the head appears as a plug-and-receptacle assembly.

The stomatological instruments may appear as a burr.

The light guide may have a lens.

The guard may be spherical-shaped and made from titanium.

The outer surface of the tip body round the head socket and the outer head surface may form conjointly a solid of revolution.

The light-emitting diodes may be connected in parallel.

The guard may be adhesive-fastened.

### ALTERNATIVE EMBODIMENTS OF THE INVENTION

The stomatological tip of the present invention has a burr 1, a lens 2 of light-emitting diode, a light-emitting diode 3, a guard 4 shaped as a hemisphere, a head 5, an electric conductor 6, a circular groove 7 and a cylinder-shaped groove 8, both being made on the outer surface of the outer portion of the head 5 and adapted to receive the electric conductor 6, a cup-shaped socket 9 to receive the head 5, an electric connector appearing as a plug 10 and a receptacle 11 and accommodated in the head 5, an electric conductor 12, a fastener unit 13 of the socket 9, a body 14 provided with a knob, a conduit 15 to receive the electric conductor 12, said conduit being extended in the body 14 and in the fastener unit 13 of the head socket 9. A retaining insert 16 and an electric insulator 17 are fixed stationary in the body 14. The retaining insert 16 holds in position the electric conductor, is associated with an electrical connector 18 and has a positive terminal 19. A holder-adapter 20 is inserted into the electrical connector 18. The light-emitting diode 3 is arranged in the head 5. The stomatological instrument may appear as a burr. The guard 4 may be spherical-shaped and made from titanium. The outer surface of the tip body 14 round the socket 9 of the head 5 and the outer surface of the head 5 may form conjointly a solid of revolution. The light-emitting diodes 3 (when two diodes are provided) may be connected in parallel. The guard 4 may be adhesive-fastened.

The stomatological tip of the invention is further provided with an air turbine accommodated in said head 5, and a means for fixing the burr 1 in place also disposed in said head 5 and adapted to be imparted rotation from said air turbine. For the sake of better understanding of the present invention, the air turbine, the means for fixing the burr in position and the rotary drive of said means are omitted in the drawings.

The stomatological tip proposed herein functions as follows.

Electric power is delivered to the light-emitting diode 2 via the electric conductor 12 enclosed in the conduit 15 and connected thereto through an electrical connector appearing as the plug 10 and the receptacle 11, and the electric conductor 6 accommodated in the circular groove 7 and the cylinder-shaped groove 8. Light radiation from the light-emitting diode 3, having passed through the lens 2, is concentrated on the operative field. The electric conductor 6 is protected against mechanical damages on the side of the outer surface of the head 5 by the guard 4.

### INDUSTRIAL APPLICABILITY

The present invention can find use in medical engineering as stomatological tips. The invention proposed herein is favorably comparable with the prototype and other heretofore known technical solutions due to having a number of advantages thereover, namely: simplified construction arrangement, higher performance reliability enabling substantially extending applicability of stomatological instruments and easier manipulating therewith in the patient's oral cavity.

1. A stomatological tip comprising a head accommodating a means for holding a stomatological instrument, a tip body having a socket to receive said head, said socket to receive said head being capable of providing a complete revolution of said head, which head is provided with a source of optic radiation, characterized in that said stomatological tip is further provided with a guard made fast on a part of the outer surface of said head, said tip being further provided with an electric power source having a positive and a negative lead appearing as a twin power cord, and said source of optic radiation appears as at least one light guide electrically connected to said power supply source via electrical connectors accommodated in said body and said head, an electric conductor enclosed in a conduit provided in said body, and in a cylinder-shaped groove and circular groove, both being made in said head, while said electrical connector accommodated in said head appears as a plug-and-receptacle assembly.

2. A stomatological tip as claimed in claim 1, characterized in that said stomatological instrument appears as a burr.

3. A stomatological tip as claimed in claim 1, characterized in that said light guide has a lens.

4. A stomatological tip as claimed in claim 1, characterized in that said guard appears as a hemisphere.

5. A stomatological tip as claimed in claim 4, characterized in that said guard is made from titanium.

6. A stomatological tip as claimed in claim 1, characterized in that the outer surface of said socket and the outer surface of said head extending from said socket form conjointly a solid of revolution.

7. A stomatological tip as claimed in claim 1, characterized in that said light-emitting diodes are connected in parallel.

8. A stomatological tip as claimed in claim 1, characterized in that said guard is adhesive-fastened.
